(19) United States
(12) Patent Application Publication
(10) Pub. No.: US 2009/0260430 A1
(43) Pub. Date: Oct. 22, 2009

(54) Method and Apparatus for Measurement of Formation Fluid Loss

(76) Inventor: Konstandinos Zamfes, Calgary (CA)

Correspondence Address: DIEDERIKS & WHITELAW, PLC, 12471 DILLINGHAM SQUARE, #301, WOODBRIDGE, VA, 22192, US

(21) Appl. No.: 12/275,388

(22) Filed: Nov. 21, 2008

Related U.S. Application Data
(60) Provisional application No. 60/996,517, filed on Nov. 21, 2007.

(51) Int. Cl. E21B 49/00; E21B 47/10; G06G 7/48

(52) U.S. Cl. 73/152.04; 73/152.03; 73/152.21; 703/10

(57) ABSTRACT

A method for determining drilling fluid losses or gains by providing a drilling fluid, measuring a plurality of supply parameters of the drilling fluid, delivering the drilling fluid to a subsurface drilling operation, the subsurface drilling operation providing a returns drilling fluid, measuring a plurality of returns parameters of the returns drilling fluid, and determining change in composition, or loss of or gain of drilling fluid from a comparison between the supply parameters and the returns parameters.

### CROSS REFERENCE TO RELATED APPLICATIONS

This application claims the benefit of priority of U.S. Provisional Patent Application No. U.S. 60/996,517 filed Nov. 21, 2007, which is incorporated herein by reference in its entirety.

### FIELD OF THE INVENTION

The present invention relates generally to oil well drilling. More particularly, the present invention relates to a method and apparatus for measurement of formation fluid loss or gains.

### BACKGROUND OF THE INVENTION

Drill bits, used in subterranean drilling, are normally run on the end of hollow drill pipe which is threaded together and to the drill bit. Drill bits can be of the rotary tri-cone type, poly-crystalline diamond compact (PDC) type or other types known to one skilled in the art. The drill pipe is rotated by rotation of the drill string and a specialized drilling mud or drilling fluid flows through the drill pipe to the drill bit to aid in the drilling process. At the point of contact with the rock formation or other material being drilled, the drill bit cutting structure gouges, scrapes and chips at the rock generally pulverizing the rock into cuttings which are removed from the drill bit cutting face by the drilling fluid. Drilling fluid is also commonly referred to as drilling mud or mud.

The mixture of drilling fluid and drilled media, referred to as drilling sludge or returns, travels upward to surface between the inside diameter of the drilled hole and the outside diameter of the drill pipe, commonly referred to as an annulus.

At the surface, the drilling sludge is processed or cleaned up to remove at least a portion of the cuttings so that the drilling fluid may be reused by circulation back downhole.

During drilling operations, large pumps are used to pump the drilling fluid downhole at great pressure and flow rate. The volume of drilling fluid pumped downhole can be calculated approximately.

The returns are monitored by a paddle or flapper monitoring the flow of returns in an oversized (i.e. not full—only partially full) pipe. During drilling operations, large returns immediately trip or activate the paddle or flapper (i.e. indicating a large increase in drilling sludge returns) and the well must be shut in and investigate—as the well is live.

It is, therefore, desirable to provide a method and apparatus of monitoring and determining fluid loss and/or gains while drilling.

### SUMMARY OF THE INVENTION

It is an object of the present invention to obviate or mitigate at least one disadvantage of previous systems for fluid loss or gains.

In a first aspect, the present invention provides a method for determining drilling fluid losses or gains in earth or rock drilling, including providing a drilling fluid to a drilling system for a drilling operation, measuring a plurality of supply parameters of the drilling fluid, delivering the drilling fluid to the subsurface drilling operation, the subsurface drilling operation providing a returns drilling fluid, measuring a plurality of returns parameters of the returns drilling fluid, and determining a change in drilling fluid composition, or loss of or gain of drilling fluid from a comparison between the supply parameters and the returns parameters.

In one embodiment, the method further includes recording a plurality of system conditions of the drilling system, and correlating the system conditions and the supply parameters or the returns parameters.

In one embodiment, the supply parameters are selected from the group of gamma ray, bulk density, temperature, velocity, heat conductivity, resistivity, and gas content. In one embodiment, the returns parameters are selected from the group of gamma ray, bulk density, temperature, velocity, heat conductivity, resistivity, cuttings, and gas content.

In one embodiment, the system conditions selected from the group of drilling rate of penetration, bit type, bit diameter, depth, rpm, cutting face depth, cuttings removed, additives added, mud pump pressure and mud pump flow output.

In one embodiment, the supply parameters are correlated to a depth of the subsurface drilling operation. In one embodiment, the returns parameters are correlated to a depth of the subsurface drilling operation.

In a further aspect, the present invention provides a method for determining the efficiency of a mud pump including, providing a stroke, a displacement, and a speed for the mud pump to determine a theoretical flow rate, measuring an actual flow rate, and comparing the actual flow rate and the theoretical flow rate.

In one embodiment, the actual flow rate is determined by velocity measurement.

In a further aspect, the present invention provides a method for modeling a borehole shape in earth or rock drilling, including providing a drilling fluid to a drilling system for a drilling operation, measuring a plurality of supply parameters of the drilling fluid, delivering the drilling fluid to the subsurface drilling operation, the subsurface drilling operation providing a returns drilling fluid, recording the depth of the drilling operation, measuring a plurality of returns parameters of the returns drilling fluid, and correlating the supply parameters, the return parameters, and depth to determining the borehole shape.

In one embodiment, an incremental section of borehole is modeled between a first depth and a second depth.

In one embodiment, a model diameter of the incremental section of the borehole is determined between the first depth and the second depth based upon a volume of the drilling fluid in the incremental section of the borehole.

In one embodiment, the volume of the drilling fluid in the incremental section of the borehole is determined from a volume of the drilling system, a volume of drilling fluid in the borehole above the first depth, a volume of drilling fluid in the drill pipe above the first depth, and a volume of the drilling fluid above ground.

In one embodiment, the model diameter is modeled in a plurality of incremental sections throughout the drilling of the borehole to provide the borehole shape.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a simplified schematic of a system of the present invention;

FIG. 2 is a first flexible sensor array of the present invention; and

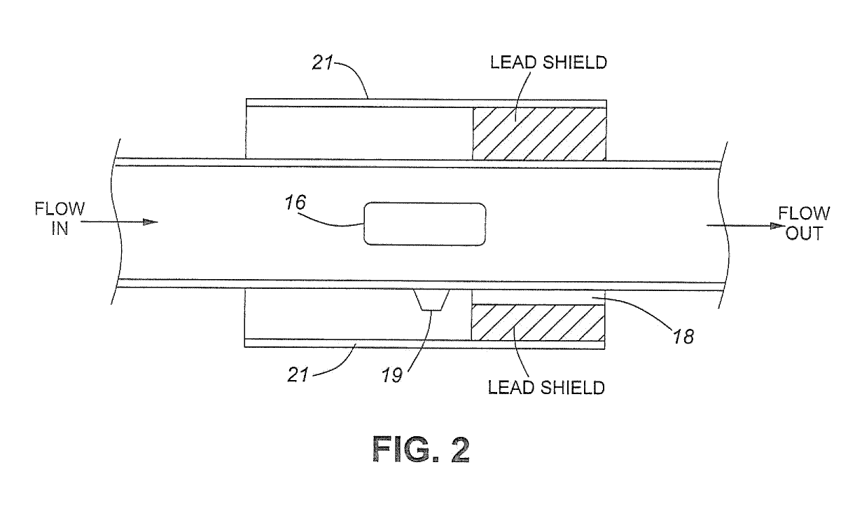

FIG. 3 is a second flexible sensor array of the present invention.

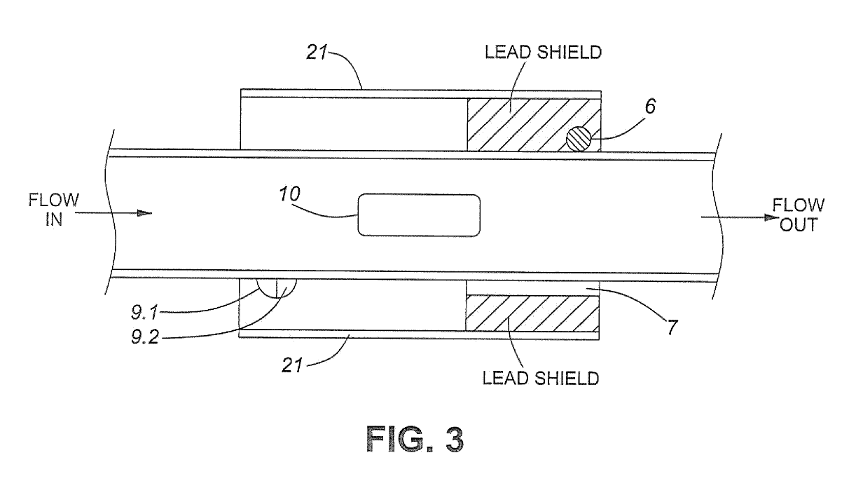

### DETAILED DESCRIPTION

Generally, the present invention provides a method, apparatus, and system for measurement of formation fluid loss or gains during subsurface formation drilling operations.

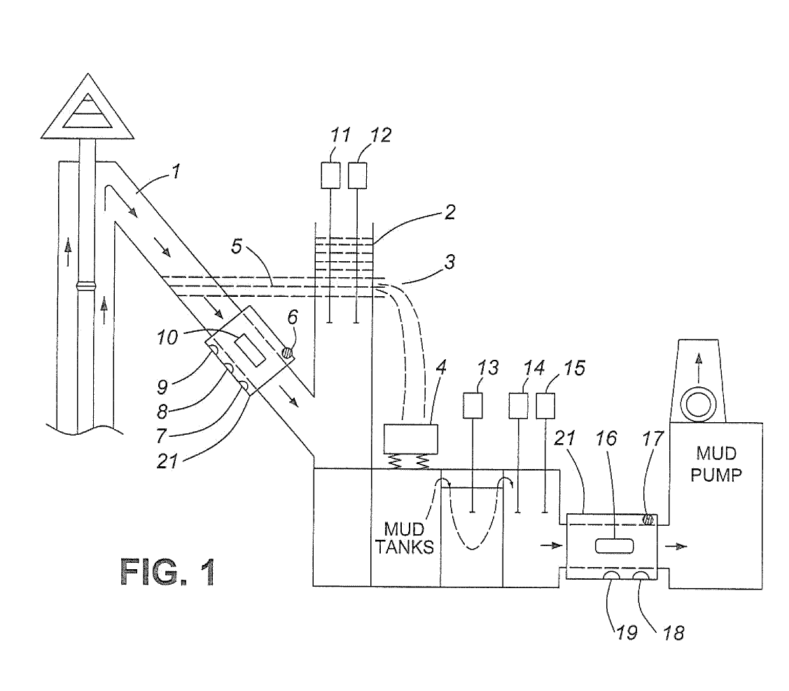

Referring to FIG. 1 drilling returns flow up the annulus 10 formed between the drill pipe 20 and the formation 30. Returns flow through a Returns Flow Line 1 through to a Possom Belly 2. A Feeder 3 delivers drilling returns to a Shaker 4. A level of drilling fluid is maintained as Mud Level 5 by the elevation of the discharge of the Feeder 3.

A plurality of sensors, which may include some or all of a Returns Gamma Ray (GR) Source 6, a Returns Discreet Bulk Density Sensor 7, a Returns Temperature probe 8, a Returns Heat Source 9.2, a Returns Temperature Probe 9.1, a Returns Doppler Velocity Meter 10 interface with the drilling fluid returns. Preferably, the sensors are mounted with a flexible sleeve, such as a Sensor Blanket 21, which may be releasably secured to the Returns Flow Line 1.

An axial (along the flow) distance may separate the Returns Heat Source 9.2 and the Returns Temperature Probe 9.1 to provide heat conduction/dissipation information.

A Returns Gas Detector 11 is adapted to detect the presence of gas in the drilling fluid returns. A Returns Resistivity Sensor 12 is adapted to measure the resistivity of the drilling fluid returns.

In Mud Tanks 40, the drilling fluid is processed or cleaned up (after removal of at least a portion of the drill cuttings after the Shaker 4). A series of compartments or tanks may be used to monitor, filter, and otherwise condition the drilling fluid for recycle the drilling fluid downhole. Typically, the last compartment or tank, just prior to the suction of the mud pumps, is used to finally condition the drilling fluid, for example by addition of additives such as weighting material or other additives.

A Sonic Level Sensor 13 measures the drilling fluid level in one or more compartments or tanks of the Mud Tanks 40. A Supply Resistivity Sensor 14 measures the resistivity and a Supply Gas Detector 15 measures the gas content of the drilling fluid.

A plurality of sensors, which may include some or all of a Supply Doppler Velocity Meter 16, a Supply Gamma Ray (GR) Source 17, a Supply Discreet Bulk Density Sensor 18, a Supply Temperature Sensor 19. Preferably, the sensors are mounted with a flexible sleeve, such as a Sensor Blanket 21, which may be releasably secured to a Pump Suction Line 50.

A number of conditions may be provided by the drilling system, related to the drilling operation, including some or all of drilling Rate of Penetration (ROP) 20.1, Bit Type 20.3, Bit Diameter 20.4, Depth 70, and Mud Pump Pressure 20.2 and Mud Pump Flow Output 20.5.

A calculation of the efficiency of the Mud Pump 70 may be determined by the comparison of the flow rate determined from the Mud Pump stroke, displacement, speed and the flow rate determined from the Doppler Meter 16 (with internal area of the Pump Suction Line 50).

In this system the drilling operation may be modeled, either concurrent with, delayed, or after the drilling operation. The model may be correlated with the Depth 70.

The volume of the drilling fluid lost or gained to the Formation 30 may be determined.

This is particularly advantageous where fracturing is important, such as coal bed methane where a drilling fluid loss indicates connectivity. In a shale or shales, an amount of formation damage may be determined by fluid loss into the formation. The damage may be correlated to the Depth 70.

The size of the Hole 60 (as a total volume or even as an incremental volume slice at a Depth 70) may be determined. This provides information as to whether fluid “losses” experienced are true fluid losses or whether the Hole 60 is merely larger than expected.

The resistivity measurement of the source drilling fluid and the drilling fluid returns provides composition information. Currently, monitoring or measuring the total system volume can not detect fluid losses when there is makeup with gas or water. That is, current systems can not detect drilling fluid loss when a volume of drilling fluid is sent downhole and the same volume (but made up of drilling fluid plus water or otherwise) is returned. Similarly, current systems can not detect drilling fluid loss when a volume of drilling fluid is sent downhole and the same volume (but made up of drilling fluid plus gas or otherwise) is returned. The system of the present invention can detect drilling fluid loss in these and other cases.

This determination may be more accurate if the salinity of the formation being drilled is known.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A method for determining drilling fluid losses or gains in earth or rock drilling, comprising:
a. providing a drilling fluid to a drilling system for a drilling operation;
b. measuring a plurality of supply parameters of the drilling fluid;
c. delivering the drilling fluid to the subsurface drilling operation, the subsurface drilling operation providing a returns drilling fluid;
d. measuring a plurality of returns parameters of the returns drilling fluid; and
e. determining a change in drilling fluid composition, or loss of or gain of drilling fluid from a comparison between the supply parameters and the returns parameters.

2. The method of claim 1, further comprising:
f. recording a plurality of system conditions of the drilling system; and
g. correlating the system conditions and the supply parameters or the returns parameters.

3. The method of claim 1, wherein the supply parameters are selected from the group consisting of gamma ray, bulk density, temperature, velocity, heat conductivity, resistivity, and gas content.

4. The method of claim 1, wherein the returns parameters are selected from the group consisting of gamma ray, bulk density, temperature, velocity, heat conductivity, resistivity, cuttings, and gas content.

5. The method of claim 1, wherein the system conditions are selected from the group consisting of drilling rate of penetration, bit type, bit diameter, depth, rpm, cutting face depth, cuttings removed, additives added, mud pump pressure and mud pump flow output.

6. The method of claim 1, wherein the supply parameters are correlated to a depth of the subsurface drilling operation.

7. The method of claim 1, wherein the returns parameters are correlated to a depth of the subsurface drilling operation.

8. A method for determining the efficiency of a mud pump comprising:
a. providing a stroke, a displacement, and a speed for the mud pump to determine a theoretical flow rate;
b. measuring an actual flow rate;
c. comparing the actual flow rate and the theoretical flow rate.

9. The method of claim 8, wherein the actual flow rate is determined by velocity measurement.

10. A method for modeling a borehole shape in earth or rock drilling, comprising:
a. providing a drilling fluid to a drilling system for a subsurface drilling operation;
b. measuring a plurality of supply parameters of the drilling fluid;
c. delivering the drilling fluid to the subsurface drilling operation, the subsurface drilling operation providing a returns drilling fluid;
d. recording the depth of the drilling operation;
e. measuring a plurality of returns parameters of the returns drilling fluid; and
f. correlating the supply parameters, the return parameters, and depth to determining the borehole shape.

11. The method of claim 10, wherein an incremental section of borehole is modeled between a first depth and a second depth.

12. The method of claim 11, wherein a model diameter of the incremental section of the borehole is determined between the first depth and the second depth based upon a volume of the drilling fluid in the incremental section of the borehole.

13. The method of claim 12, wherein the volume of the drilling fluid in the incremental section of the borehole is determined from a volume of the drilling system, a volume of drilling fluid in the borehole above the first depth, a volume of drilling fluid in the drill pipe above the first depth, and a volume of the drilling fluid above ground.

14. The method of claim 12, wherein the model diameter is modeled in a plurality of incremental sections throughout the drilling of the borehole to provide the borehole shape.
